(19) United States
(12) Patent Application Publication
(10) Pub. No.: US 2015/0256122 A1
(43) Pub. Date: Sep. 10, 2015

(54) THREE-DIMENSIONAL PHOTOVOLTAIC CELL

(71) Applicant: Michael Conner Babb, Galloway, OH (US)

(72) Inventor: Michael Conner Babb, Galloway, OH (US)

(21) Appl. No.: 14/641,882

(22) Filed: Mar. 9, 2015

Related U.S. Application Data
(60) Provisional application No. 61/950,055, filed on Mar. 8, 2014.

(51) Int. Cl. H02S 20/20

(52) U.S. Cl. CPC H02S 20/20

(57) ABSTRACT

A triangular prism that gathers sunlight is disclosed. This invention improves on the amount of electricity that can be produced over time per square foot using sunlight.

### CROSS-REFERENCES TO RELATED APPLICATIONS

This application claims the benefit of U.S. Provisional Application No. 61/950,055 filed Mar. 8, 2014. The above prior application is hereby incorporated by reference.

### STATEMENT REGARDING FEDERALLY-SPONSORED RESEARCH AND DEVELOPMENT

(Not Applicable)

### THE NAMES OF THE PARTIES TO A JOINT RESEARCH AGREEMENT

(Not Applicable)

### REFERENCE TO AN APPENDIX

(Not Applicable)

### BACKGROUND OF THE INVENTION

The invention relates generally to photovoltaic panels, and more particularly to a photovoltaic cell configuration that provides more area of the cells' surfaces per unit of area masked from the sun, than previous cell configurations.

It is well known to place photovoltaic (solar) cells on rooftops, fields and other locations so that they can be exposed to photons radiating from the sun. These locations are often seen as “wasted space” due to their low value and inability to be used for other purposes. However, even if such space has a low value that does not mean such space is of no value or unlimited in quantity. Furthermore, because the labor costs involved in installing solar cells is emerging as a major portion of the expense of the investment, it is desirable to place as much “photovoltaic area” in as small of a portion of this space as is possible, thereby maximizing the solar collection density.

Conventional devices to collect sunlight, including photovoltaic cells, have a collecting surface that is typically planar and is aligned with the angle of the roof or other surface on which they are mounted. While such planar surfaces are not necessarily exactly parallel to the roof or the ground, they tend to have planar surfaces that are all aligned in a similar orientation toward the sun's path of travel over them—perpendicular to the sun. Such structures are limited in their ability to collect sunlight due to the area that each photovoltaic cell occupies, and the amount of area that is available for reasonable use.

### BRIEF SUMMARY OF THE INVENTION

This invention improves on the amount of electricity that can be produced over time per square foot using sunlight. The invention solves the need for more space when installing photovoltaic systems within a limited (or somewhat limited) area. The inventor believes that prior art devices cannot collect as much energy from the sun's rays as the present invention due to the limitations in the prior art. Prior art devices cannot, in some situations, produce enough electricity to satisfy the need of those who install them due to the limited space in which they are put.

The invention solves the need for more space when installing photovoltaic systems within a limited area, by allowing for more photovoltaic cells to be placed in a limited space. This is accomplished, in one embodiment, by placing the cells atop a triangular prism so that the photovoltaic cells are housed at the angle of the triangular prism. The three-dimensional solar panel collects more sunlight per unit area that they occupy (i.e., area that is covered up by the base), compared to conventional, flat, perpendicularly-oriented panels, due to the angling of the cells thereon. This improves the amount of electricity that can be produced per unit area.

In one embodiment of the invention, the solar cells are formed in “triangular waves” across a panel in which the cells are housed. The tips of the waves are aligned to the South (for Northern hemisphere locations) or the direction that faces the sun for the longest period of each day, or during the portion of the day that the sun's radiation is most intense, or at an orientation that maximizes the amount of the sun's radiation that is collected.

In one embodiment of the invention, each wave is about four inches tall (from the plane perpendicular to the bottom of the panel) and about four feet long, with solar cells that are about six inches wide on all sides, with seven cells housed in each row. Each panel houses at least two rows and the angle between each of the rows is about 45 degrees, although this can be varied, from at least 30 degrees to at least 60 degrees.

### BRIEF DESCRIPTION OF THE SEVERAL VIEWS OF THE DRAWINGS

FIG. 1 is a view in perspective illustrating a preferred embodiment of the present invention.

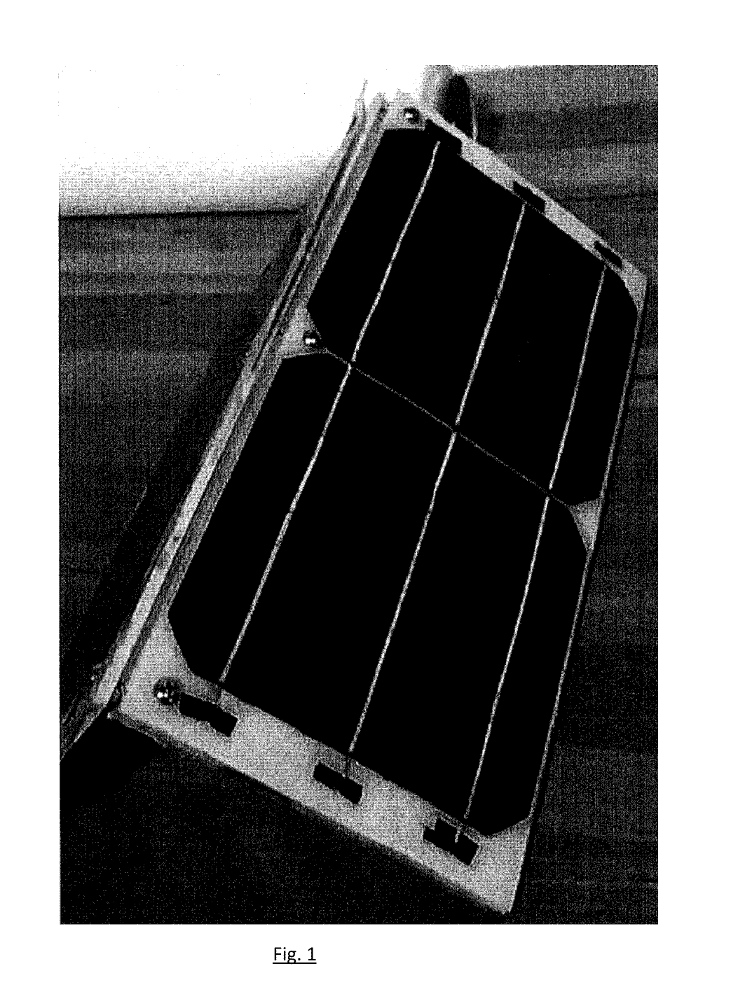

FIG. 2 is a view in perspective illustrating a preferred embodiment of the present invention.

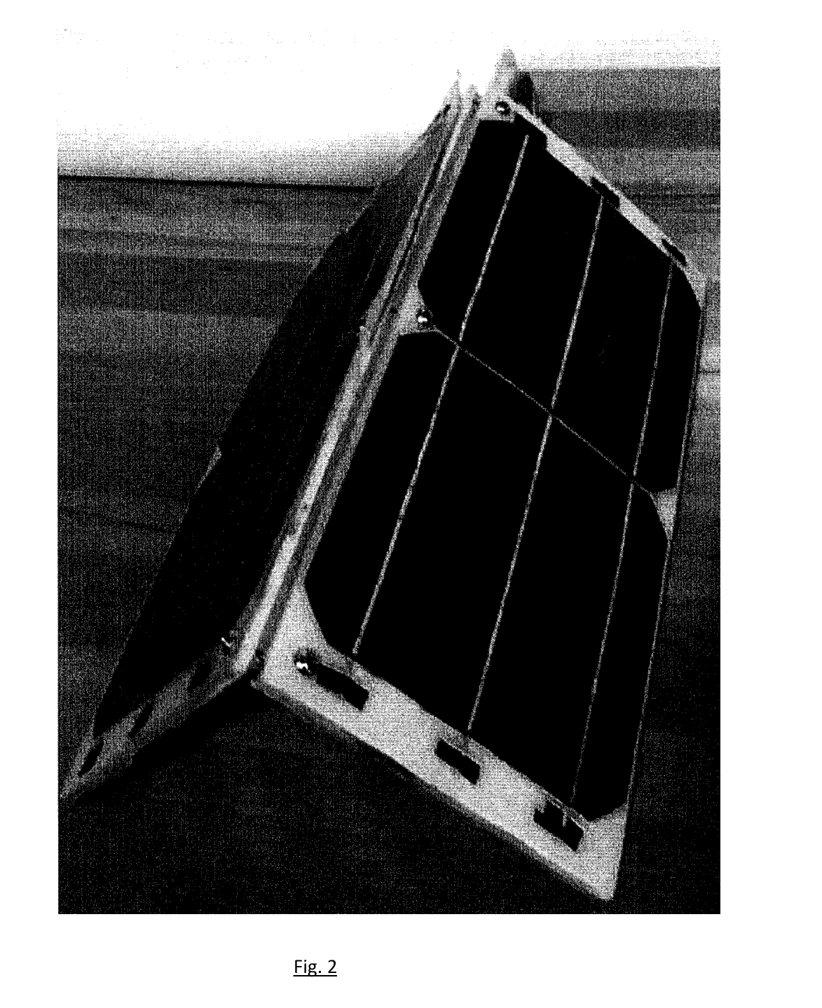

FIG. 3 is a view in perspective illustrating a preferred embodiment of the present invention.

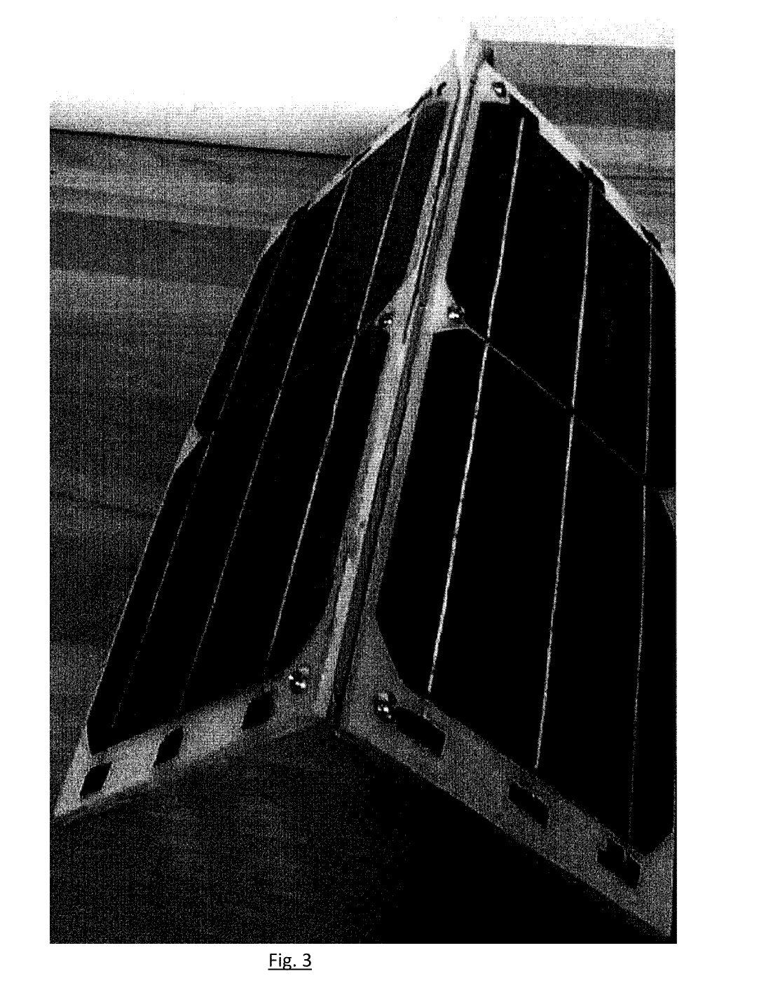

FIG. 4 is a view in perspective illustrating a preferred embodiment of the present invention.

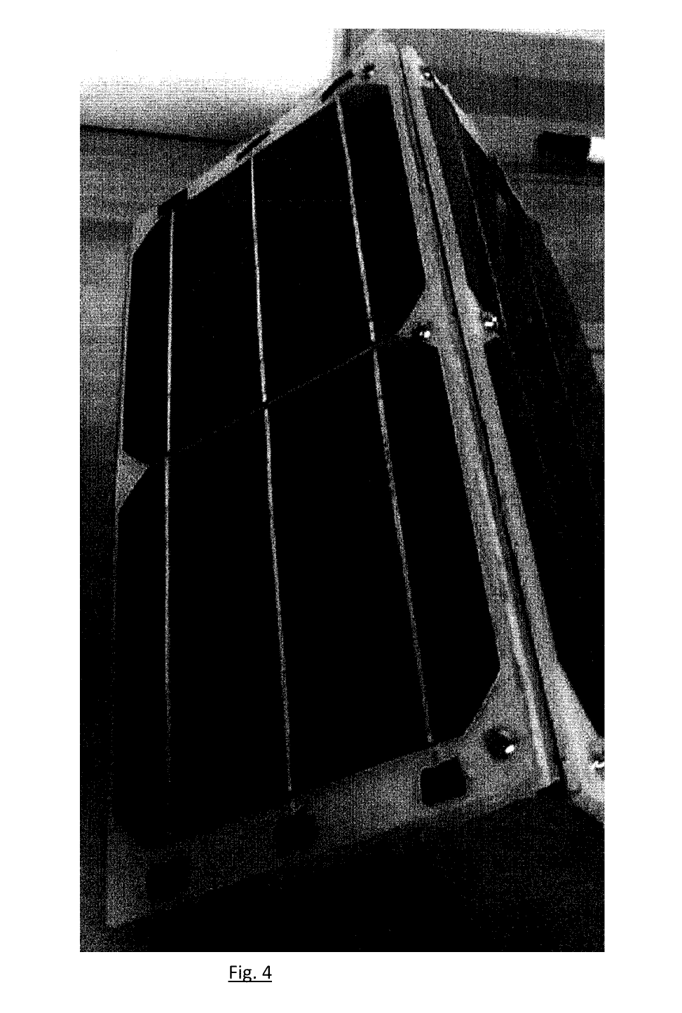

FIG. 5 is a view in perspective illustrating a preferred embodiment of the present invention.

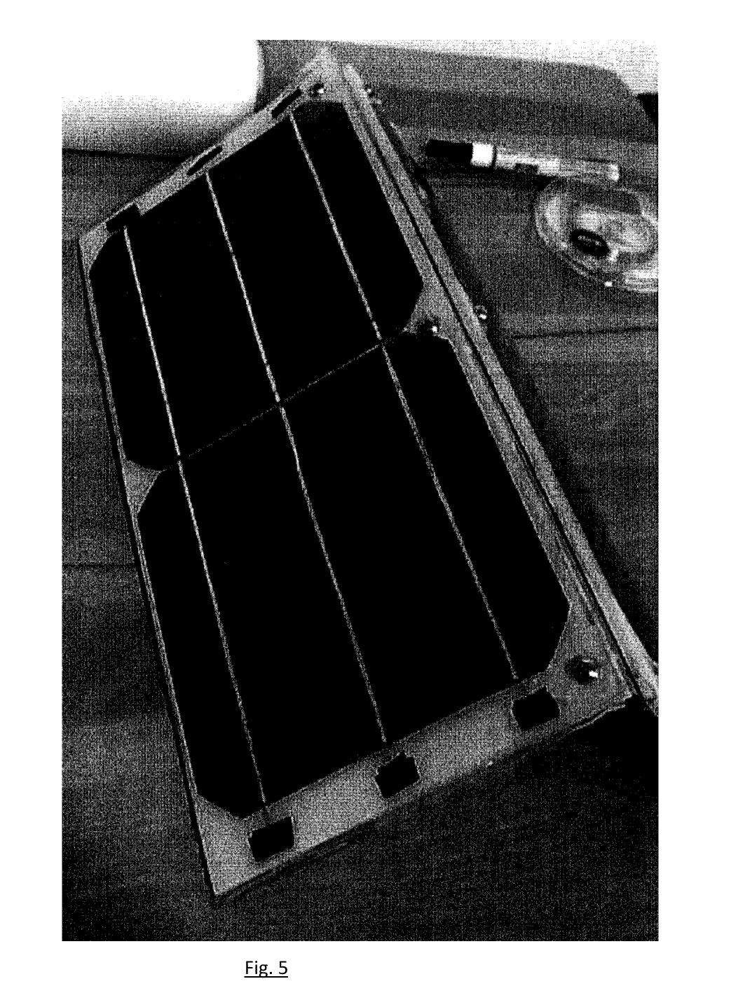

FIG. 6 is a view in perspective illustrating a preferred embodiment of the present invention.

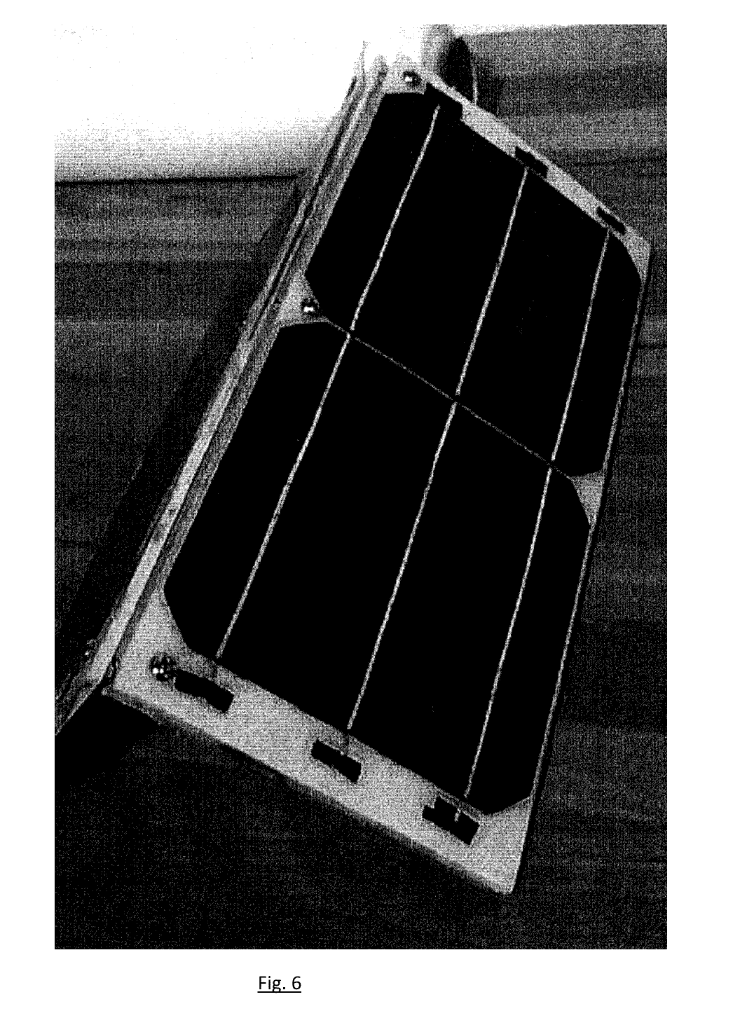

In describing the preferred embodiment of the invention which is illustrated in the drawings, specific terminology will be resorted to for the sake of clarity. However, it is not intended that the invention be limited to the specific term so selected and it is to be understood that each specific term includes all technical equivalents which operate in a similar manner to accomplish a similar purpose. For example, the word connected or terms similar thereto are often used. They are not limited to direct connection, but include connection through other elements where such connection is recognized as being equivalent by those skilled in the art.

### DETAILED DESCRIPTION OF THE INVENTION

U.S. Provisional Application No. 61/950,055 filed Mar. 8, 2014 is incorporated in this application by reference.

1. triangular-prism strong enough to support impact of storms

2. silicon photovoltaic solar cells

3. wiring

Relationship Between the Components:

Two sides of the (1) triangular-prism are covered with (2) cells. (2) Cells on one side are (3) wired together in series and (2) cells on another side are (3) wired together in series.

How the Invention Works:

The cells produce electricity from sunlight and the triangular prism houses the cells. The wiring transports the electricity to be used.

How to Make the Invention:

The cells are tabbed together and secured to the side of the triangular prism shaped base, then another side is covered in cells. The third side is made to be mounted to a roof or ground mounting. The triangular prism shape could be comprised of three individual planks then attached together when mounted. Or the two sides covered in cells could be mounted alone without the bottom of the prism so long as they remain oriented in the same angle.

How to Use the Invention:

A person could install this solar panel in a space with limited room to create more electricity in that same area than a flat solar panel. Also, it can create: 3-dimensional Solar panel.

This detailed description in connection with the drawings is intended principally as a description of the presently preferred embodiments of the invention, and is not intended to represent the only form in which the present invention may be constructed or utilized. The description sets forth the designs, functions, means, and methods of implementing the invention in connection with the illustrated embodiments. It is to be understood, however, that the same or equivalent functions and features may be accomplished by different embodiments that are also intended to be encompassed within the spirit and scope of the invention and that various modifications may be adopted without departing from the invention or scope of the following claims.

1. A photovoltaic cell system comprising:
(a) a triangular-prism strong enough to support impact of storms;
(b) silicon-based photovoltaic solar cells mounted to and covering a first side of the triangular-prism and silicon-based photovoltaic solar cells mounted to and covering a second side of the triangular-prism; and
(c) wiring extending in series between the solar cells on the first side and wiring extending in series between the solar cells on the second side.
